(19) United States
(12) Patent Application Publication
(10) Pub. No.: US 2003/0099165 A1
(43) Pub. Date: May 29, 2003

(54) Wristwatch case with rotary bezel

(76) Inventor: Dai Terasawa, Chiba-shi (JP)

Correspondence Address: Adams & Wilks, 50 Broadway 31st Floor, New York, NY, 10004, US

(21) Appl. No.: 09/979,714

(22) PCT Filed: May 29, 2001
(86) PCT No.: PCT/JP01/02694

(51) Int. Cl. G04B 37/00; G04B 39/00

(52) U.S. Cl. 368/294

(57) ABSTRACT

A rotary bezel (1) is stopped at a lower stop point by a positioning elastic member (105) held by a positioning groove (12) of the rotary bezel (1) and a positioning projection (25) of a case body (2). At this moment, a rotation stop portion (43) provided to a rotation restricting ring (4) is engaged with a single or a plurality of rotation stop holes (23) perforated to the case body (2) by which the rotation restricting ring (4) cannot be rotated. By pulling the rotary bezel (1) to move in a vertical direction, a positioning elastic member (105) held by a positioning groove (12) of the rotary bezel (1) is bent and rides over the positioning projection (25) of the case body (2). At this moment, the positioning elastic member (105) held by positioning groove (12) of the rotary bezel (1) interferes with a positioning projection upper inclined face (27) of the case body (2) by which the rotary bezel (1) can be stopped at an upper stop point and at the upper stop point, the rotary bezel (1) can stably be rotated. Under the state, engagement between the gear-like recessed and projected portion (13) of the rotary bezel (1) and a rotation restricting portion (41) of the rotation restricting ring (4) fixed to the case body (2) is completely released and the rotary bezel (1) can freely be rotated.

### TECHNICAL FIELD

The present invention relates to a wrist watch case.

### BACKGROUND OF THE INVENTION

FIG. 16 shows a sectional view of a principal structural portion of a conventional rotary bezel. According to a wrist watch case mounted with the conventional rotary bezel, the rotary bezel can be rotated. However, the rotary bezel cannot be moved in the vertical direction. Therefore, according to the wrist watch case mounted with the conventional rotary bezel, there pose the following problems.

(1): Although there is provided a function of rotating the rotary bezel, in order to ensure stability in a stationary state of the rotary bezel, bezel rotating torque must be heavy.

(2): Owing to (1), a shape of large recesses and projections is obliged to constitute at a surface of the rotary bezel.

According to the invention, it is a problem thereof to resolve the above-described problems and provide a wrist watch case mounted with a rotary bezel easy to rotate with no necessity of heavy rotating torque and a recessed and projected shape at a surface of the rotary bezel while ensuring stability in a stationary state of the rotary bezel.

Further, FIG. 17 shows a sectional view of a principal structural portion of a conventional rotary bezel. Although a wrist watch case mounted with the conventional rotary bezel is frequently used mainly for diving and a reverse rotation preventive structure is adopted, when strong external force is exerted such as colliding with a hazard or the like in operation in water, there is a case in which the rotary bezel is erroneously operated. When the rotary bezel for displaying a time period of diving is erroneously operated, the diving time period becomes unclear. According to the invention, it is a problem thereof to resolve the above-described problems and provide a wrist watch case mounted with a rotary bezel capable of firmly preventing erroneous operation of the rotary bezel constituting a concern in the conventional rotary bezel structure by providing a rotation locking mechanism.

### DISCLOSURE OF THE INVENTION

A rotary bezel is constructed by a structure having a function of capable of moving substantially in a vertical direction relative to a plane of a wrist watch case and in an operational range in the vertical direction, there are provided a plurality of stop points, that is, the plurality of stop points are divided into a stop point for ensuring stability of stopping rotation and a stop point for rotating the rotary bezel. Thereby, when the rotary bezel is brought into a rotatable state, rotating torque can be minimized.

According to the invention, at the stop point for ensuring the stability of stopping rotation, recesses and projections in a shape of a gear provided to the rotary bezel, are engaged with rotation restricting portions of a gear in a recessed and projected shape of a rotation restricting ring to thereby firmly restrict rotation and at the stop point for rotating thereof, the engagement is released from the rotation restricting portions of the rotation restricting ring and the rotating torque can be minimized.

Further, the rotary bezel is constructed by the structure having the function of capable of moving substantially in the vertical direction relative to the plane of the wrist watch case and in the operational range in the vertical direction, there are provided a plurality of stop points, that is, the plurality of stop points divided into a stop point for locking rotation of the rotary bezel and a stop point for rotating the rotary bezel.

According to the invention, at the stop point for locking the rotation of the rotary bezel, recesses and projections in a shape of a gear provided to the rotary bezel in the direction of a section thereof, are engaged with a rotation stop pin head of a rotation stop pin to thereby firmly restrict rotation of the rotary bezel and at the stop point for rotating thereof, the engagement is released and the rotary bezel can be rotated.

According to an aspect of the invention, there is provided a wrist watch case with a rotary bezel comprising a rotary bezel having a gear-like recessed and projected portion at a bottom face thereof on an inner side of an outer configuration thereof, a rotation restricting ring disposed on a lower side of the rotary bezel and having a rotation restricting portion engaged with the gear-like recessed and projected portion at a lower stop point of the rotary bezel and a click elastic projection engaged with the gear-like recessed and projected portion at an upper stop point of the rotary bezel, having an apex higher than an apex of the rotation restricting portion and contained in a click elastic portion containing portion at the lower stop point, and a case body (2) disposed on a lower side of the rotation restricting ring for receiving the rotation restricting ring.

### BRIEF DESCRIPTION OF THE DRAWINGS

FIG. 1 is a sectional view of a principal structural portion of a lower stop point of a rotary bezel according to the invention.

FIG. 2 is a sectional view of a principal structural portion of an upper stop point of the rotary bezel according to the invention.

FIG. 3 is a sectional view of a principal structural portion of the lower stop point of the rotary bezel according to the invention.

FIG. 4 is a sectional view of a portion taken along an A-A′ arrow mark direction of the lower stop point of the rotary bezel according to the invention.

FIG. 5 is a sectional view of a principal structural portion of the upper stop point of the rotary bezel according to the invention. FIG. 6 is a sectional view of a portion taken along a B-B′ arrow mark direction of the upper stop point of the rotary bezel according to the invention.

FIG. 7 is a plane view of a ring elastic part according to the invention.

FIG. 8 is aside view taken along a C-C′ arrow mark direction of the ring elastic part according to the invention.

FIG. 9 is a sectional view of a principal structural portion of a lower stop point of a rotary bezel according to the invention.

FIG. 10 is a sectional view of a principal structural portion of an upper stop point of the rotary bezel according to the invention.

FIG. 11 is a sectional view of a principal structural portion of the lower stop point of the rotary bezel according to the invention.

FIG. 12 is a sectional view of a portion taken along an A-A′ arrow mark direction of the lower stop point of the rotary bezel according to the invention.

FIG. 13 is a sectional view of a principal structural part of the upper stop point of the rotary bezel according to the invention.

FIG. 14 is a sectional view of a portion taken along a B-B′ arrow mark direction of the upper stop point of the rotary bezel according to the invention.

FIG. 15 is a plane view of a ring elastic part according to the invention.

FIG. 16 is a sectional view of a principal structural portion of a conventional rotary bezel.

FIG. 17 is a sectional view of a principal structural portion of a conventional rotary bezel.

### BEST MODE FOR CARRYING OUT THE INVENTION

<Embodiment 1>

An explanation will be given of an embodiment of the invention in reference to the attached drawings as follows.

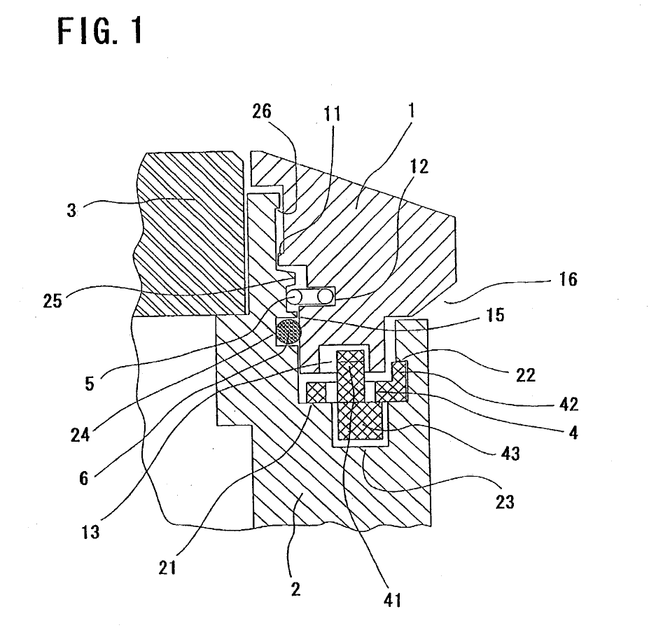

As shown by FIG. 1, the invention is constituted by a rotary bezel 1 having a degree touch stepped difference 11, a positioning groove 12 holding a positioning elastic member 105, and a gear-like recessed and projected portion 13, a case body 2 having a bezel degree contact face 26 and a positioning projection 25, and a rotation restricting ring 4 having a rotation stop portion 43 engaged with a rotation stop hole 23 and a rotation restricting portion 41 in correspondence with the gear-like recessed and projected portion 13 and fixed to the case body 2.

FIG. 1 shows a state in which a rotary bottom face 14 is brought into contact with a rotary bezel receive face 21 and the state is defined as a lower stop point. The rotary bezel 1 can be stopped at the lower stop point by the positioning elastic member 105 and the positioning projection 25 of the case body 2.

By engaging the rotation stop portion 43 having the rotation restricting ring 4 with a single or a plurality of the rotation stop holes 23 perforated. at the case body 2, the rotation restricting ring 4 remains unrotated. At this occasion, by engaging the gear-like recessed and projected portion 13 of the rotary bezel 1 with the rotation restricting portion 41 of the rotation restricting ring 4 fixed to the case body 2, the rotary bezel 1 is ensured with stationary stability and remains unrotated.

The rotation restricting portion 41 of the rotation restricting ring 4 fixed to the case body 2, is disposed at a single or a plurality of locations.

By bringing a play stopping elastic member 6 fitted to a fixed groove 24 of the case body 2 into contact with an elastic member contact face 15 of the rotary bezel 1, the stationary stability of the rotary bezel 1 is further ensured. Glass 3 is fixed to a stepped difference portion provided at the case body by adhesion or welding. Further, the rotary bezel 1 is operated by providing a finger touching inclined face 16 at a lower face of an outer periphery thereof and attaching the finger to the finger touching inclined face 16. Therefore, it is preferable that the finger touching inclined face 16 is constituted by an angle which is easy to rotate by the finger.

The case body 2 is provided with a circumferential groove upper face wall 22 in an outer peripheral direction at a face directed orthogonally to the rotary bezel receive face 21 of the case body 2. A detaching preventive projection 42 disposed at an upper face of the rotation restricting ring 4 is attached to the circumferential groove upper face wall 22.

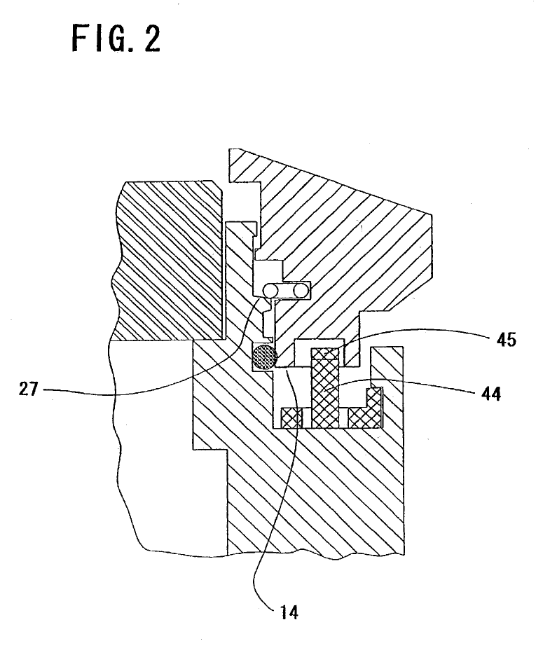

FIG. 2, shows a state in which by touching the finger to the finger touching inclined face 16 and pulling the rotary bezel 1 to move in the vertical direction, the positioning elastic member 105 held by the positioning groove 12 of the rotary bezel 1, is bent and rides over the positioning projection 25 of the case body 2.

At this occasion, by interference of the positioning elastic member 105 held by the positioning groove 12 of the rotary bezel 1, with a positioning projection upper inclined face 27 of the case body 2, the rotary bezel 1 can be stopped at the upper stop point and at the upper stop point and the rotary bezel 1 can stably be rotated.

Under the state, engagement between the gear-like recessed and projected portion 13 of the rotary bezel 1 and the rotation restricting portion 41 of the rotation restricting ring 4 fixed to the case body 2 is completely released and the rotary bezel 1 can freely be rotated.

The rotation restricting ring 4 is provided with the detaching preventive projection 42 such that when the rotary bezel 1 is moved to the upper stop point, the rotation restricting ring 4 fixed to the case body 2 is not moved to the upper stop point along with the rotary bezel 1. By interference of the detaching preventive projection 42 of the rotation restricting ring 4 with the circumferential groove upper face hole 22 of the base body 2, the rotation restricting ring 4 is prevented from moving to the upper stop point.

At the upper stop point, the rotary bezel is brought into a rotatable state. A click elastic portion 44 which is pushed by the rotary bezel bottom face 14 and contained in a click elastic portion containing portion 46 at the lower stop point, rises by elastic force of its own when the rotary bezel 1 is brought into the state of the upper stop point and interferes pertinently with the gear-like recessed and projected portion 13 of the rotary bezel 1.

At this occasion, when the rotary bezel 1 is rotated, a click elastic projection 45 provided at the click elastic portion 44 of the rotation restricting ring 4, is moved in an up and down direction by rotating force and intermittently interferes with the gear-like recessed and projected portion 13 formed in a direction of a section of the rotary bezel 1 to thereby give a click feeling to the rotary bezel 1.

The click elastic portion 44 and the click elastic projection 45 of the rotation restricting ring 4 each is disposed at a single or a plurality of locations.

The rotary bezel 1 is provided with the degree touch stepped differences 11 and the case body 2 is provided with the bezel degree contact portion 26 such that the rotary bezel is not detached from the case body 2 when the rotary bezel 1 is moved in an upper direction.

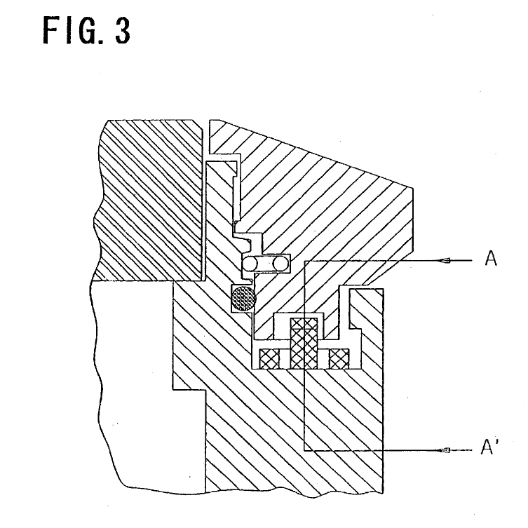

FIG. 3 shows a state in which the rotary bezel 2 is disposed at the lower stop point. A cut position is shown by a line A-A′ in order to show a relationship among the rotary bezel 1, the rotation restricting ring 4 and the case body 2.

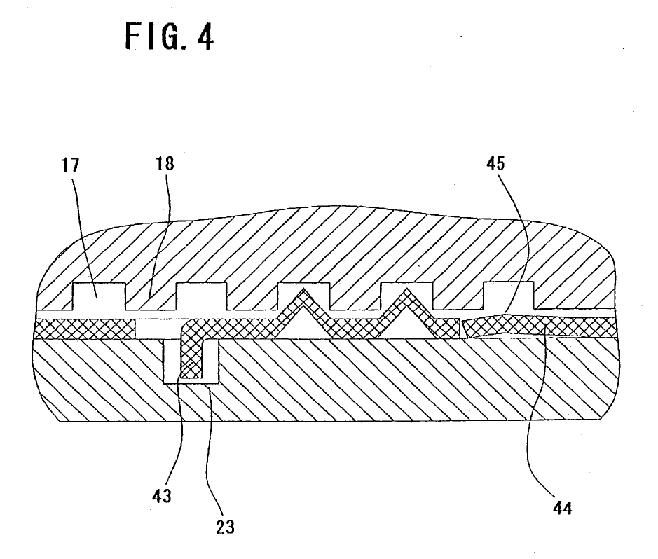

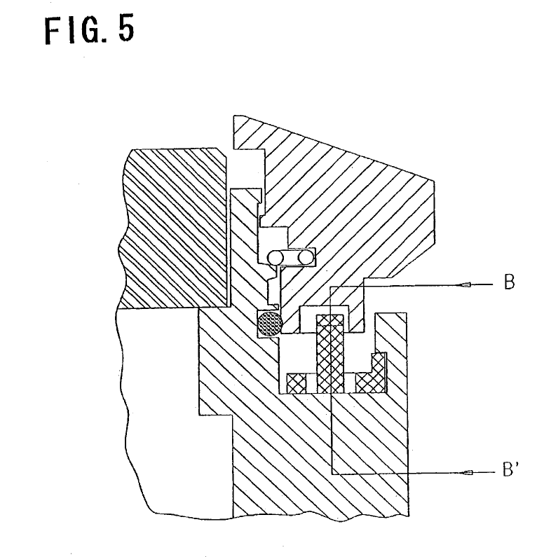

FIG. 4 shows a state of viewing a portion cut in FIG. 3 from the line A-A′. At a lower face of the rotary bezel 1, there are alternately provided gear recessed portions 17 and gear projected portions 18 in a circumferential direction. The rotation restricting ring 4 is arranged below the rotary bezel 1. The rotation restricting ring 4 is provided with several portions bent in a triangular shape and an interval of arranging the portions corresponds to the gear recessed portions 17. Further, an upper portion of the portion bent in the triangular shape is fitted to the gear recessed portion 17. Further, the rotation restricting ring 4 is provided with the click elastic portion 44 slightly bent to an upper side in order to output the click feeling when rotated. Further, the rotation restricting ring 4 is provided with the rotation stop portion 43 a portion of which is bent to a lower side. The rotation stop portion 43 is for preventing the rotation restricting ring 4 from being rotated even when the rotary bezel 1 is rotated. The rotation stop portion 43 is inserted into the rotation stop hole 23 provided at the case body 2. The case body 2 is arranged below the rotation restricting ring 4.

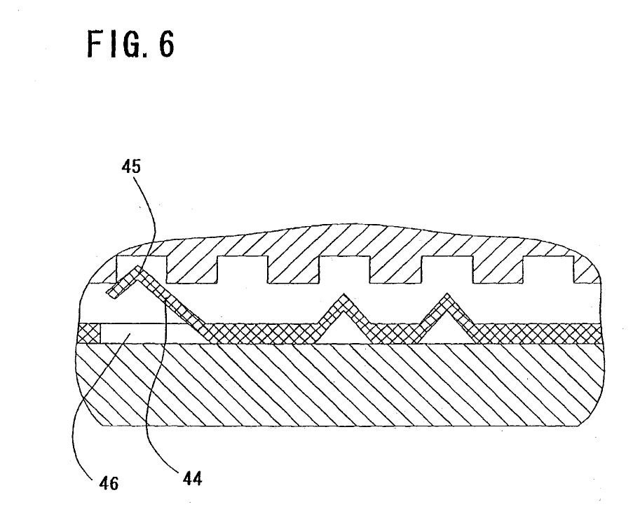

FIG. 5 shows a state in which the rotary bezel 1 is disposed at the upper stop point. In order to show a relationship among the rotary bezel 1, the rotation restricting ring 4 and the case body 2, a cut position is shown by a line B-B′. FIG. 6 shows a state of viewing the portion cut in FIG. 5 from the line B-B′. When the rotary bezel 1 is disposed at the upper stop point, the gear recessed portions 17 and the gear projected portions 18 are disposed at a position higher than apexes of portions of the rotation restricting ring 4 bent in a triangular shape. Therefore, the portions of the rotation restricting ring 4 bent in the triangular shape, are not in mesh with the gear recessed portions 17 and the gear projected portions 18. The gear recessed portion 17 is in mesh with the click elastic projection provided at the rotation restricting ring 4. The click elastic projection 45 comprises the click elastic portion 44 and a portion a front end of which is bent to a lower side. When the rotary bezel 1 is rotated, the click elastic portion 44 is deformed to a side of the case body 2 to thereby produce the click feeling. When the rotary bezel 1 is disposed at the lower stop point, the click elastic portion 44 is contained in the click elastic portion containing portion 46.

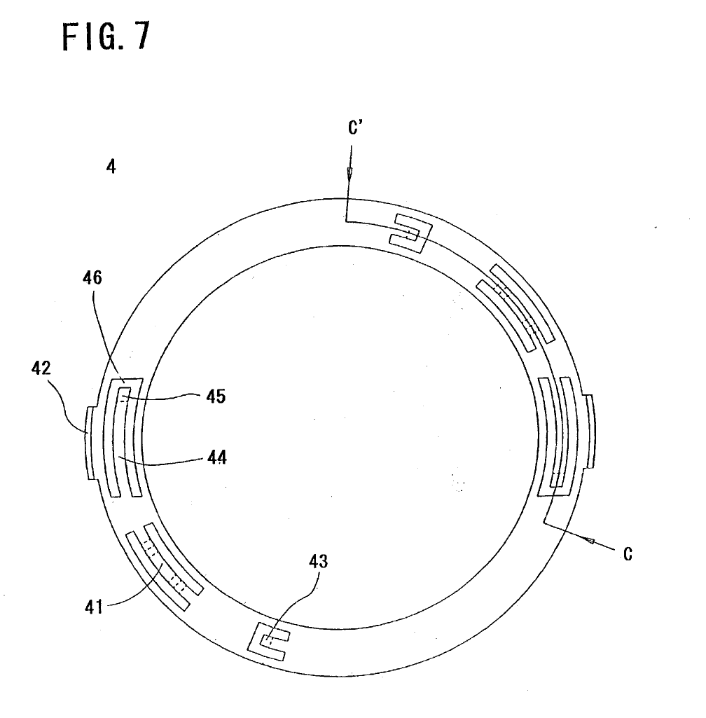

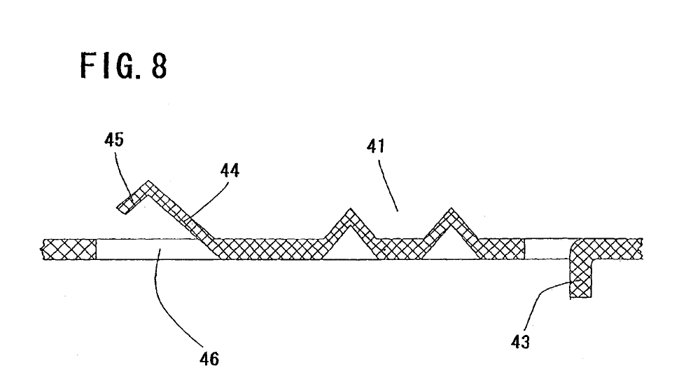

FIG. 7 is a plane view of a ring elastic member part according to the invention. FIG. 8 is a side view viewing the rotation restricting ring 4 according to the invention shown in FIG. 7 in a C-C′ arrow mark direction. The rotation restricting ring 4 is formed in a doughnut shape. In order to prevent the rotation restricting ring 4 from being detached, there are provided the detachment preventive projections 42 at two locations in an outer periphery of the rotation restricting ring 4. When the detaching preventive projections 42 are disposed at the two locations, it is preferable that positions thereof are disposed in a diagonal direction. The detaching preventive projections 42 may be provided at three or more locations. In that case, the detaching preventive projections 42 may be provided at angles as uniform as possible.

The click elastic portion 44 is provided on an inner side of the detaching preventive projection 42. The click elastic portion 44 is bent in an upper direction and a front end portion thereof is bent to a lower side. The bent portion constitutes the click projection 45. Under a state in which load is not applied to the rotation restricting ring 4, the position of the apex of the click projection 45 is higher than a section of a triangular shape, mentioned later. A peripheral portion of the click elastic portion 44 and the click elastic projection 45 on the rotation restricting ring 4, is hollowed such that when force is exerted from an upper direction on the click projection 45 and the click elastic portion 44, these can be contained in the rotation restricting ring 4. The portion constitutes the click elastic portion containing portion 46.

Further, the rotation restricting ring 4 is provided with the rotation restricting portions 41. Two sets of the rotation restricting portions 41 are provided with two of them as one set along a circumference. It is preferable that the rotation restricting portions 41 are disposed at diagonal positions as much as possible. Three or more sets thereof may be provided and three or more pieces thereof may constitute one set. The number of pieces and the number of sets constitute one factor for producing the click feeling. The rotation restricting portion 41 is constituted by a section in a triangular shape such that an apex thereof is disposed in an upper face direction. When the rotation restricting portion 41 is fabricated along the circumference to thereby constitute hollow portions on an inner diameter side and an outer diameter side thereof, fabrication of the rotation restricting portion 41 is facilitated to thereby constitute one factor of determining touch of the click feeling.

Further, in order to prevent the rotation restricting ring 4 from being rotated, there are provided the rotation stop portions 43 in the rotation restricting ring 4. The rotation stop portions 43 are provided at two locations along the circumference in a diagonal direction. The rotation stop portions 43 may be provided at three or more locations. In that case, it is preferable that positions for providing thereof are as uniform as possible. A front end of the rotation stop portion 43 is bent on a lower side of a lower face of the rotation restricting ring 4.

According to the invention, when the rotary bezel 1 is disposed at the lower stop point, the gear recessed and projected portion 13 is engaged with the rotation restricting portion 41 of the rotation restricting ring 4 and the rotary bezel 1 cannot be rotated. Meanwhile, when the rotary bezel is disposed at the upper stop point, the mesh between the gear-like recessed and projected portion 13 and the rotation restricting portion 41 of the rotation restricting ring 4 is released and the rotary bezel 1 can freely be rotated. Thereby, there can be realized a wrist watch case having a function of rotating the rotary bezel 1 which differs by stop positions.

As a result, in contrast to a current state in which according to the conventional rotary bezel structure having no positional change in the vertical direction, as a result of commonly providing the stop stability and the rotational operability, the rotating torque of the rotary bezel needs to be heavy and provision of a recessed and projected shape is necessarily needed at a surface or an outer peripheral portion of the rotary bezel in order to provide sufficient torque when the rotary bezel is operated to rotate by the finger, there can be realized the wrist watch case with the rotary bezel guaranteed with the stop stability and the rotational operability even when the recessed and projected shape is not provided to the surface or the outer peripheral portion of the rotary bezel, further, the rotating torque can be minimized and therefore, the rotary bezel can be rotated smoothly. Further, an effect of capable of resolving a restriction on design of the rotary bezel which needs the recessed and projected shape to thereby enlarge the degree of freedom of design is enormous.

As shown by FIG. 5, it is possible that in the state in which the rotary bezel 1 is disposed at the upper stop point, there is produced slight interference by the gear-like recessed and projected portion 13 and the click elastic projection 45 provided at the click elastic portion 44 to thereby provide free rotation of the rotary bezel 1 with the click feeling.

<Embodiment 2>

An explanation will be given of an embodiment of the invention in reference to the attached drawings as follows.

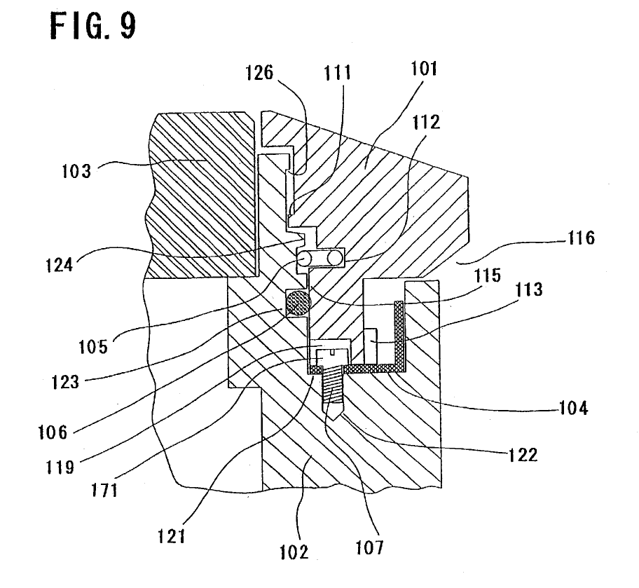

FIG. 9 is a sectional view of a principal structural portion when a rotary bezel is disposed at a lower stop point. As shown by FIG. 9, the invention is constituted by a rotary bezel 101 having a degree touch stepped difference 111, a positioning groove 112 holding a positioning elastic member 105 and a gear-like recessed and projected portion 13, a case body 102 having a positioning projection 124, a rotation restricting pin 107 engaged with a rotation stop hole 122 and having a rotation restricting pin head 171 in correspondence with a rotation restricting groove 119, and a rotation click ring 104 fixed to the case body 102 by the rotation restricting pin 107.

A stepped difference portion is provided at a face of an inner side of the case body 102 and glass 103 is fixed to the stepped difference portion by welding or adhesion. At an upper portion of the case body 102, there is provided a portion recessed to an inner side. A positioning projection 126 provided on an upper side of the recessed portion, interferes with the degree touch stepped difference 111 of the rotary bezel 101 and restricts a position of the rotary bezel 101 in an upper direction when the rotary bezel 101 is lifted to an upper side. Meanwhile, the positioning projection inclined face portion 124 provided on a lower side of the recessed portion, is provided with inclined faces at an upper face and a lower face thereof. The upper face of the positioning projection inclined face portion 124 is constituted by the inclined face falling toward an outer periphery thereof and the lower face is constituted by the inclined face rising toward the outer periphery. There is provided a fixed groove 123 directed to an inner side, on a lower side of the positioning projection inclined face portion 124. A play stopping elastic member 106 is attached to the fixed groove 123. The play stopping elastic member 106 absorbs play of the rotary bezel 101 when the rotary bezel 101 is rotated and when the rotary bezel 101 is moved in an up and down direction. Further, the case body 102 is provided with a groove directed to a lower side, on a lower side of the play stopping elastic member 106. The rotation click ring 104 is mounted on a rotation click ring receive face 21 constituting a lower face of the groove. The rotation click ring 104 is fixed by screwing the rotation stop pin 107 having a screw portion to a lower side of the case body 102.

The rotary bezel 101 is arranged at an upper portion of the rotation click ring 104 to cover an upper portion of the case body 102. The positioning groove 112 is provided from a face on an inner side of the rotary bezel 101 toward an outer side. The positioning elastic member 105 is inserted into the positioning groove 112. The positioning elastic member 105 is disposed on a lower side of a lower face of the positioning projection inclined face portion 124 in the state in which the rotary bezel 101 is disposed at the lower stop point. At the lower face of the rotary bezel 101, there is provided the rotation restricting groove 119 which is not brought into contact with the rotation stop pin head 71 of the rotation stop pin 7. There is provided a gear-like recessed and projected portion 113 on an outer side of the rotation restricting groove 119 and on an inner side of a portion of the rotation click ring 104 bent in the vertical direction. Further, there is provided a finger touching inclined face 116 on the outer side of the rotary bezel 101 and on the upper side of the case body to make the rotary bezel 101 easy to rotate from an outer periphery toward an inner side thereof.

FIG. 9 shows a state in which a rotary bezel bottom face 114 is brought into contact with a rotary bezel receive face 142 of the rotation click ring 104 fixed to the case body 102 by the rotation restricting pin 107 and the state is defined as the low stop point. The rotary bezel 101 can be stopped at the lower stop point by the positioning elastic member 105 held by the positioning groove 112 of the rotary bezel 101 and the positioning projection 124 of the case body 102.

By penetrating the rotation restricting pin 107 to a fixed hole 141 of the rotation click ring 104 and fixing the rotation restricting pin 107 to the fixed hole 122 of the case body 102, the rotation click ring 104 remains unrotated and is not moved in the vertical direction relative to a plane. Although with regard to a method of fixing the case body 102 and the rotation restricting pin 107, these are fixed by a screw, there may be adopted a strike-in type providing a fastening margin to pin diameter of the rotation restricting pin 107 and the fixed hole 122 of the case body 102, or the fixed hole 122 of the case body and the rotation restricting pin 107 may be adhered to each other.

In this case, by bringing the rotation restricting groove 119 of the rotary bezel 101 and the rotation restricting pin head 171 of the rotation restricting pin 107 fixed to the case body 102 in mesh with each other, the rotary bezel 101 cannot be rotated and the stop stability is also ensured.

By bringing the play stopping elastic member 106 fitted to the fixed groove 122 of the case body 102 and an elastic member contact face 115 of the rotary bezel 101 into contact with each other, the stationary stability of the rotary bezel 101 is further ensured.

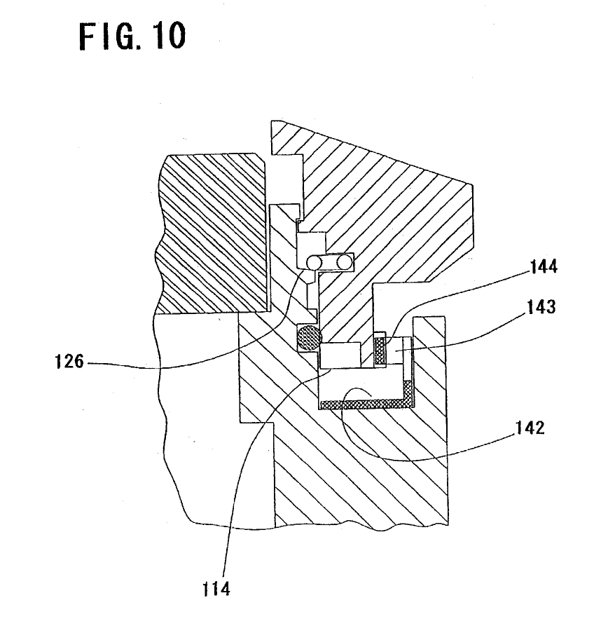

FIG. 10 shows a sectional view in a state in which the bezel 101 is disposed at an upper stop point. When the finger is touched to the finger touch inclined face 116 and the rotary bezel 101 is pulled to move in the vertical direction relative to the plane, the positioning elastic member 105 held by the positioning groove 112 of the rotary bezel 101 is bent and rides over the positioning projection 124 of the base body 102. The state constitutes the upper stop point of the rotary bezel 101.

At this occasion, the rotary bezel 101 can be stopped at the upper stop point by interference of the positioning elastic member 105 held by the positioning groove 112 of the rotary bezel 101 with the positioning projection 124 of the case body 102. Even when the rotary bezel is intended to pull up further to the upper side, the positioning projection 126 and the degree touch stepped difference 111 interfere with each other and the rotary bezel 101 is not moved on an upper side thereof. Thereby, the rotary bezel 101 can stably be rotated at the upper stop point.

Under the state, engagement between the gear-like recessed and projected portion 113 of the rotary bezel 101 and the rotation restricting pin head 171 of the rotation restricting pin 107 fixed to the case body 102, is completely released and the rotary bezel 101 can be rotated.

At the upper stop point, the gear-like recessed and projected portion 113 of the rotary bezel 101 and a click elastic projection 144 provided at a click elastic portion 143 of the rotation click ring 104 fixed to the case body 102, are brought in mesh with each other.

When the rotary bezel 101 is rotated, the click elastic projection 144 provided at the click elastic portion 143 of the rotation click ring 104, is moved in a radial direction by rotating force and intermittently interferes with the gear-like recessed and projected portion 113 of the rotary bezel 101 to thereby provide the rotary bezel 101 with the click feeling.

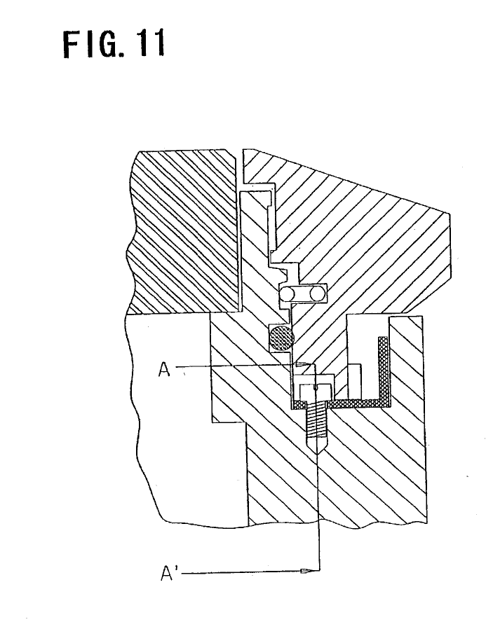

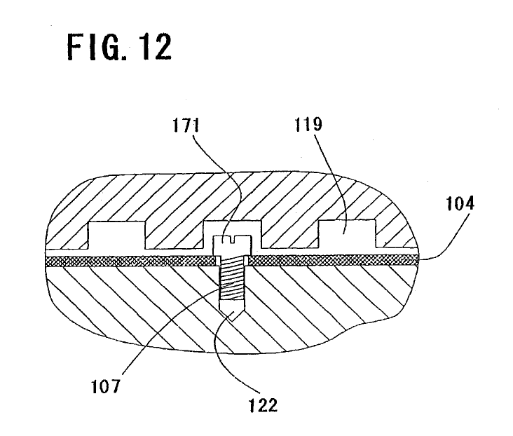

FIG. 11 is a drawing of a state in which the rotary bezel 101 is disposed at the lower stop point. FIG. 12 is a partial sectional view viewing from an A-A′ direction of FIG. 11. At the lower face of the rotary bezel 101, there are provided a plurality of the rotation restricting grooves 119 at constant intervals along a circumference. On the lower side of the rotary bezel 101, the rotation click ring 104 is fixed to the case body 102 by the rotation stop pin 107. The rotation stop pin 107 is screwed to the rotation stop hole 122 extended to the lower side of the case body 102. At this occasion, the rotation stop pin head 171 of the rotation stop pin 107 is contained in the rotation restricting groove 119. Therefore, even when the rotary bezel 101 is intended to rotate, the rotation stop pin head 171 of the rotation stop pin 107 interferes with the rotation restricting groove 119 of the rotary bezel 101, thereby, the rotation can be restricted.

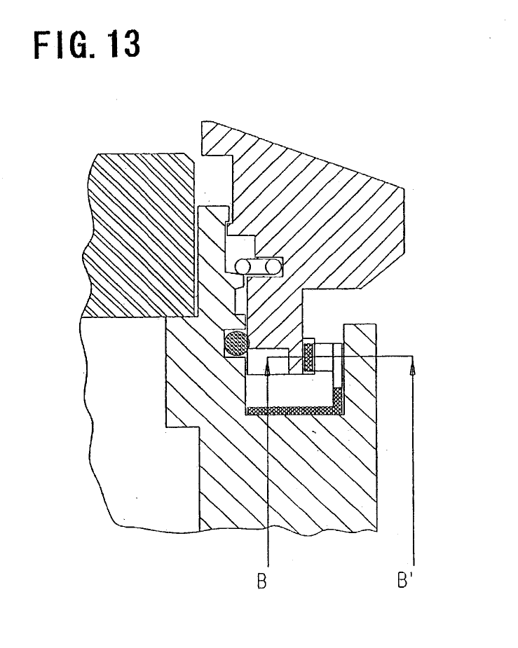

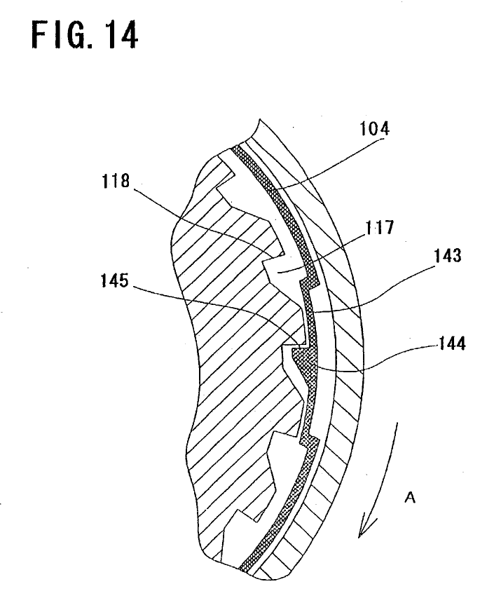

FIG. 13 shows the state in which the rotary bezel 101 is disposed at the upper stop point. FIG. 14 shows a partial sectional view viewing from a direction of a line B-B′ shown in FIG. 13. There are provided gear recessed portions 117 at constant intervals at an outer periphery of the rotary bezel 101. The gear recessed portion 117 is provided with a rotation restricting wall 118 at a face thereof directed to the center relative to a circumferential direction and is provided also with an inclined face directed from an outer periphery thereof toward an inner side. The rotation click ring 104 is arranged on an outer side of the rotary bezel 101. The rotation click ring 104 is provided with the click elastic member 143 recessed from an outer periphery thereof to an inner side. The click elastic projection 114 is provided on an inner peripheral side of the click elastic member 143. The click elastic projection 114 is provided with a rotation stop wall 145 interfering with the rotation restricting wall 118. Further, the click elastic member projection 114 is provided with an inclined face directed from an inner periphery toward an outer periphery thereof. The case body 102 is arranged on the outer side of the rotation click ring 104.

An explanation will be given of a case in which the rotary bezel 101 is going to be rotated in an A direction under the state. The rotation restricting wall 118 of the rotary bezel 101 interferes with the rotation stop wall 145 of the click elastic projection 114 provided at the rotation click ring 104. The rotation click ring 104 is fixed and therefore, the rotary bezel 101 cannot be rotated. Meanwhile, an explanation will be given of a case in which the rotary bezel 101 is going to be rotated in a direction opposed to the A direction. The inclined face of the gear recessed portion 117 of the rotary bezel 101 is brought into contact with the inclined face of the click elastic member projection 144. At this occasion, the inclined face of the gear recessed portion 117 rides over the click elastic projection 114 by deforming the click elastic member 143 to an outer side and moving the click elastic member projection 144 to the outer side. The click feeling is produced by deforming the click elastic member 143.

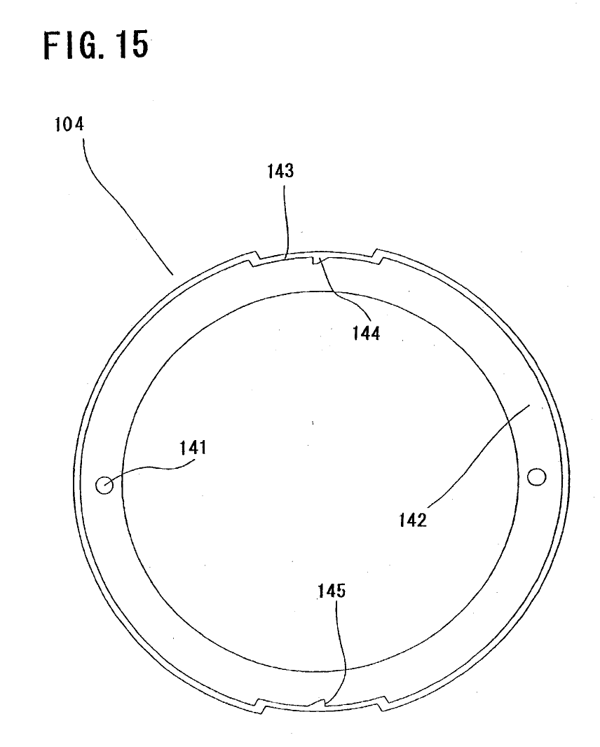

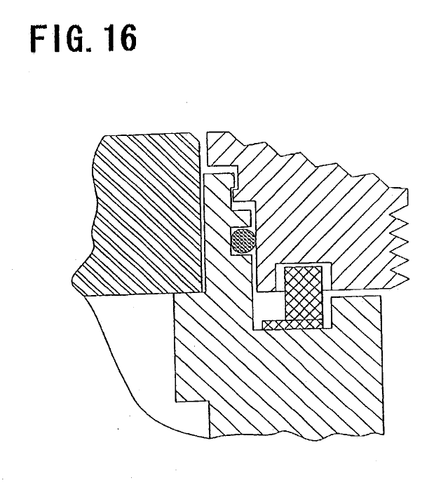

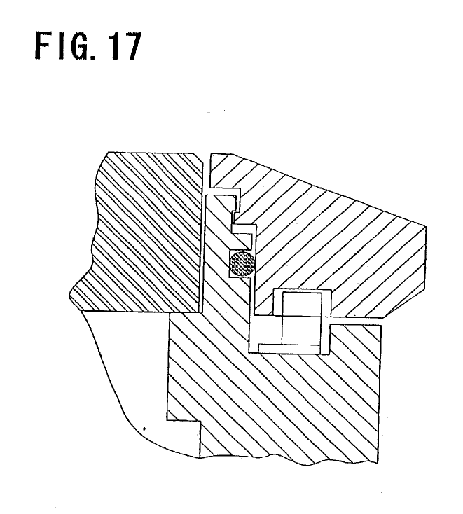

FIG. 15 shows a plane view of the rotation click ring 104. The rotation click ring 104 comprises a rotary bezel receive face 142 in a ring-like shape and a hollow cylindrical portion extended from the rotary bezel receive face 142 upward from the paper face. The rotary bezel receive face 142 is provided with the fixed holes 141 for fixing the location click ring at two locations thereof. The click elastic portions 143 are provided at two locations at positions substantially orthogonal to a line connecting the two fixed holes 141. The click elastic projection 144 is provided on an inner side of the click elastic portion 143. Further, numbers of the fixed holes 141 and the click elastic portions 143 are not limited to two but may be any. Further, the positional relationship between the fixed holes 141 and the click elastic portions 143 may not be orthogonal.

According to the invention, as described above, when the rotary bezel 101 is disposed at the lower stop point, the gear-like recessed and projected portion 113 is engaged with the rotation restricting pin 171 of the rotation restricting pin 107 and the rotation bezel 101 cannot be rotated. Meanwhile, when the rotation bezel 101 is disposed at the upper stop point, the mesh between the gear-like recessed and projected portion 113 and the rotation restricting pin 171 of the rotation restricting pin 107, is released, the rotation bezel 101 can be rotated and in this way, there can be realized the rotary bezel structure of the wrist watch case in which the function of rotating the rotary bezel 101 differs by the stop positions.

As a result, there can be realized the rotary bezel structure of the wrist watch case in which the rotation locking mechanism can be provided to the rotary bezel and erroneous operation of the rotary bezel by external force constituting a concern in the conventional rotary bezel structure, can firmly be prevented.

### INDUSTRIAL APPLICABILITY

As described above, the wrist watch case with the rotary bezel according to the invention, ensures the stability in the stationary state of the rotary bezel and is useful by being used in a case of a wrist watch capable of lightening bezel rotating torque.

1. A wrist watch case with a rotary bezel which is a wrist watch case having a rotary bezel (1) and having a structure in which the rotary bezel (1) is capable of moving substantially in a vertical direction relative to a plane of the wrist watch case, wherein a rotating mechanism having a function of rotating the rotary bezel (1) which differs by a plurality of stop points in a moving range in the vertical direction is enabled by arranging a rotation restricting ring (4) having a circumference between the rotary bezel (1) and a case body (2).

2. The wrist watch case with a rotary bezel according to claim 1, wherein a gear-like recessed and projected portion (13) of the rotary bezel (1) is formed with respect to a sectional shape thereof.

3. The wrist watch case with a rotary bezel according to claim 1, wherein the rotation restricting ring (4) is constituted by a rotation restricting ring having a click elastic projection (45) interfering with a gear-like recessed and projected portion (13) formed at the rotary bezel (1) with respect to a direction of a section thereof and moving in an up and down direction by a rotating force produced at the gear-like recessed and projected portion (13) when the rotary bezel (1) is rotated and producing a click feeling by intermittently interfering with the gear-like recessed and projected portion (13).

4. A wrist watch case with a rotary bezel comprising:
a rotary bezel (101) having gear recessed portions and gear projected portions on an outer side thereof;
a rotation click ring (104) which is provided on a lower side of the rotary bezel (101) and in which mesh between click elastic projections (144) and the gear recessed portions and the gear projected portions is disengaged when the rotary bezel (101) is disposed at a position of a lower stop point and the click elastic projections (144) and the gear recessed portions and the gear projected portions are brought in mesh with each other when the rotary bezel (101) is disposed at a position of an upper stop point; and
a case body (102) arranged on a lower side of the rotation click ring (104).

5. The wrist watch case with a rotary bezel according to claim 4, wherein the rotary bezel (101) is rotated only in a constant direction.

6. A wrist watch case with a rotary bezel comprising:
a rotary bezel (1) having a gear-like recessed and -projected portion (13).at a bottom face thereof on an inner side of an outer configuration thereof;
a rotation restricting ring (4) disposed on a lower side of the rotary bezel and having a rotation restricting portion (41) engaged with the gear-like recessed and projected portion (13) at a lower stop point of the rotary bezel (1) and a click elastic projection (45) engaged with the gear-like recessed and projected portion (13) at an upper stop point of the rotary bezel (1), having an apex higher than an apex of the rotation restricting portion (41) and contained in a click elastic portion containing portion (46) at the lower stop point; and a case body (2) disposed on a lower side of the rotation restricting ring (4) for receiving the rotation restricting ring (4).
